(19) United States
(12) Patent Application Publication
(10) Pub. No.: US 2008/0046224 A1
(43) Pub. Date: Feb. 21, 2008

(54) Apparatus and method for predicting disease

(75) Inventor: Chulso Moon, Lutherville, MD (US)

Correspondence Address: HOWREY LLP, C/O IP DOCKETING DEPARTMENT, 2941 FAIRVIEW PARK DR, SUITE 200, FALLS CHURCH, VA, 22042-2924, US

(73) Assignee: Cangen Biotechnologies, Inc., Bethesda, MD (US)

(21) Appl. No.: 11/730,021

(22) Filed: Mar. 29, 2007

Related U.S. Application Data
(60) Provisional application No. 60/786,841, filed on Mar. 29, 2006.

(51) Int. Cl. G06G 7/48

(52) U.S. Cl. 703/11

(57) ABSTRACT

The present invention relates generally to an apparatus and methods for predicting disease and, more specifically, to an apparatus and methods for detecting and diagnosing cancer. One embodiment of the present invention may include generating mass spectra data from a sample taken from a subject and comparing the sample to a prediction model to assess whether or not the subject has a specific disease. Another embodiment of the present invention may include generating a first set of mass spectra data from samples taken from a population known to have a disease and generating a second set of mass spectra data from samples taken from a population known not to have the disease. The two sets of mass spectra data may then be compared to identify markers in the spectra data indicating the presence of the disease.

### RELATED U.S. APPLICATIONS

This application claims the benefit of U.S. provisional Application No. 60/786,841, filed Mar. 29, 2006 and entitled “Methods of Predicting Cancer.” The foregoing application is hereby incorporated herein by reference.

### FIELD OF THE INVENTION

The present invention relates generally to an apparatus and method for predicting disease. More specifically, the present invention relates to methods of early prediction and diagnosis of cancer based on mass spectra data.

### BACKGROUND OF THE INVENTION

Cancer is one of the leading causes of death in the industrialized countries. One of the most deadly types of cancer is lung cancer, with the chances of a patient surviving for five-years being approximately 14%., Head and neck cancer, or head and neck squamous cell carcinoma (“HNSCC”), is also a major problem, with more than 500,000 cases diagnosed each year. Additionally, thousands of individuals are diagnosed each year with other types of cancer including, but not limited to, oral cancer, kidney cancer, bladder cancer, pancreatic cancer, esophageal cancer and pharyngeal cancer. As such, scientists are continually researching and working on improving diagnostic and therapeutic methods for detecting and treating cancer. However, despite these efforts, the overall survival rate (measured five years after diagnosis) of cancer patients remains low.

The low overall survival rate of cancer patients is due largely to the lack of effective methods for diagnosing cancer early enough to provide sufficient treatment. The development of lung, head and neck, oral, esophageal- and pharyngeal cancers requires the repeated introduction of carcinogens, typically tobacco smoke, in the upper aero-digestive tract for a prolonged period of time. The development of the cancer, called carcinogenesis, can take many years and results in the accumulation of multiple molecular abnormalities in cells, which are the basis of malignant transformation and tumor progression. Unfortunately, cancer is often not detected until the patient's cancer has progressed significantly. For example, only fifteen percent of patients with lung cancer are currently diagnosed when tumors are at a localized stage. Even these patients have an expected five year survival rate of only approximately 50%. Likewise, the five-year survival rate for patients suffering from HNSCC is approximately 50%. It is estimated that these survival rates may be increased up to eighty percent with earlier detection and treatment of the cancers.

Some previous methods for detecting cancers have included bronchoscopy, cytopathology and lung scans. Bronchoscopy, a procedure that allows a physician to see inside of a patient's airway, and lung scans are tools that have been used for detecting lung cancer. Cytopathology, a method of analyzing cell structures and examining cell interaction, may be used for detecting a variety of types of cancer. However, these methods all require significant progression of cancer before they are capable of detecting the presence of cancer.

Additionally, distal lung cancer (which accounts for approximately 40% of cancer cases in Europe) may be sensitively detected using a method known as spiral computed tomography (“spiral CT”). While spiral CT is one of the most effective techniques currently available for detecting small peripheral nodules which are indicative of cancer, it is not capable of detecting early proximal bronchial lesions.

Sputum cytology, which involves examining a patient's saliva for the presence of abnormal-cells, has also been used for detecting cancers. However, this technique is very specific and time consuming and, unfortunately, is not highly sensitive. Therefore, its effectiveness in detecting cancers is less than desirable.

Based on the foregoing, there is a clear need for an improved method of predicting and diagnosing cancer early in its development in order to increase the likelihood of effective treatment, or at least prolong the survival, of cancer patients.

### SUMMARY OF THE INVENTION

The present invention relates generally to an apparatus and method for predicting disease. More specifically, the present invention relates to methods of early prediction and diagnosis of cancer based on mass spectra data.

One embodiment of the present invention may include a method of detecting the presence of a disease in a subject. The method may comprise the steps of generating mass spectra data from a biological sample taken from the subject and comparing the mass spectra data to a prediction model, the prediction model being based on mass spectra data of biological samples taken from a population known to have the disease. A match between the mass spectra data from the sample and the prediction model may indicate that the subject has the disease.

Another embodiment of the present invention may include a method of identifying a marker for a disease for use in detecting the disease in a subject. The method may comprise the steps of generating a first set of mass spectra data, the first set of mass spectra data being generated from biological samples taken from a population known to have the disease, generating a second set of mass spectra data, the second set of mass spectra data being generated from biological samples taken from a population known not to have the disease and comparing the first set of mass spectra data and the second set of mass spectra data to identify at least one peak indicating at least one marker for the disease.

These and other objects and advantages of the invention will be apparent from the following description, the accompanying drawings and the appended claims.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 shows an apparatus according to one embodiment of the present invention.

FIG. 2A shows a method according to one embodiment of the present invention.

FIG. 2B shows another method according to one embodiment of the present invention.

FIGS. 3A-3K are mass spectra of normal sera according to one embodiment of the present invention.

FIGS. 3L-3S are mass spectra of sera from patients known to have lung cancer according to one embodiment of the present invention.

FIGS. 4A-4U are mass spectra of sera from patients known to have pancreatic cancer according to one embodiment of the present invention.

FIGS. 5A-5C are mass spectra of sera from patients known to have bladder cancer according to one embodiment of the present invention.

FIGS. 5D-5F are mass spectra of normal sera according to one embodiment of the present invention.

### DETAILED DESCRIPTION OF THE INVENTION

The present disclosure will now be described more fully with reference to the Figures in which various embodiments of the present invention are shown. The subject matter of this disclosure may, however, be embodied in many different forms and should not be construed as being limited to the embodiments set forth herein.

Evidence has emerged which demonstrates that genetic abnormalities occur early in the carcinogenic process, particularly in the lungs and oral cavity of chronic smokers. A number of genetic and molecular alterations, such as mutations in the p53 tumor suppressor gene and K-ras proto-oncogene, promoter hypermethylation of the p16 tumor suppressor gene, and loss of heterozygosity in multiple critical chromosome regions, have been identified in the early stages of cancer. It has been found that the detection and identification of these biomarkers early in the development of cancer leads to the ability to sensitively and specifically diagnose a patient in the early stages of cancer. This, in turn, may lead to an increase in the likelihood of effective treatment, or at least prolong the survival, of cancer patients.

Accordingly, the present invention relates to a method and system for early detection and diagnosis of cancers in a patient based on an analysis of mass spectra data, as discussed in detail below. While, for simplicity and illustrative purposes, the principles of the present invention are described by referring to specific types of cancers or samples with respect to humans, one of ordinary skill in the art will realize that this is not intended to be limiting. Thus, one of ordinary skill in the art will realize that the present invention may be utilized for the detection of a variety of common types of diseases by analyzing a variety of common types of samples taken from a variety of organisms.

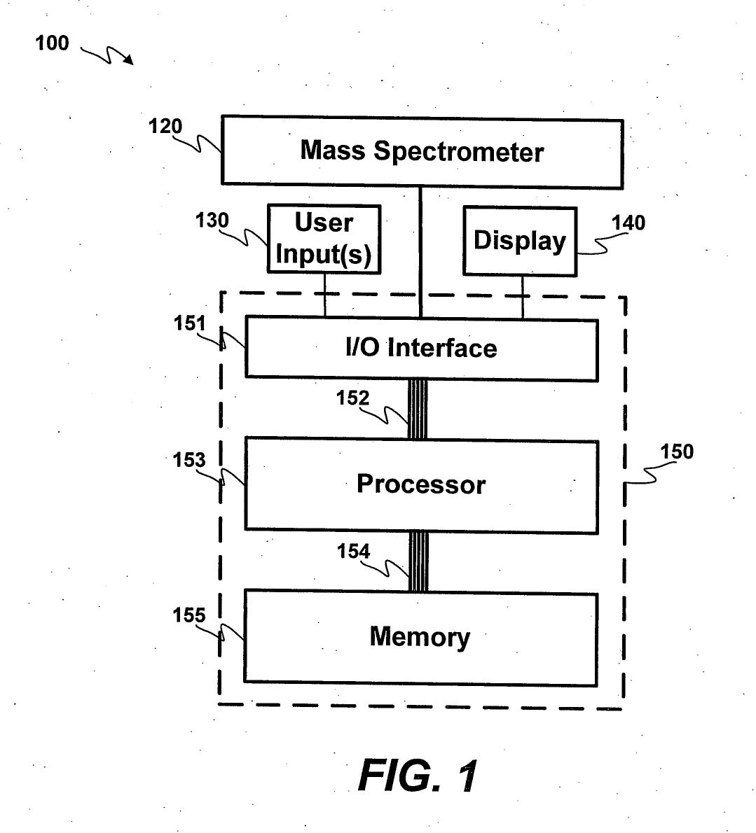

FIG. 1 shows an apparatus 100 according to one embodiment of the present invention. As illustrated in FIG. 1, one embodiment of the present invention may include a mass spectrometer 120. As will be apparent to one of ordinary skill in the art, the mass spectrometer 120 may be used for measuring the mass-to-charge ratio of ions in a sample. The mass spectrometer 120 may ionize the sample and may first separate ions in the sample having differing masses and then may record each ion's relative abundance in the sample by measuring the intensities of ion flux. The results of the mass spectrometry may then be produced in a mass spectrum, which may be represented- in a figure that looks like a chromatogram or spectrogram.

It is contemplated that any type of mass spectrometer may be utilized with the present invention including, but not limited to, spectrometers that utilize sector, time-of-flight (“TOF”), quadrupole, quadrupole ion trap, linear quadrupole ion trap, fourier transform ion cyclotron resonance, liquid chromatography/mass spec/mass spec (“LC/MS/MS”) or orbitrap mass analysis. Furthermore, any type of mass spectrometry technique may be utilized by the present invention provided the technique is within the scope and spirit of the present invention. This may include the use of any well known mass spectrometry technique including, but not limited to, matrix-assisted laser desorption/ionization (“MALDI”), electrospray ionization (“ESI”) or LC/MS/MS.

As further illustrated in FIG. 1, the present invention may also include a processor-based system 150, user inputs 130 and a display 140. In one embodiment, the processor-based system 150 may include an input/output (“I/O”) interface 151, through which the mass spectrometer 120 may be connected to the processor-based system 150. In alternative embodiments, various I/O interfaces may be used as I/O interface 151 as long as the functionality of the present invention is retained.

According to one embodiment of the present invention, the processor-based system 150 may be used to control the mass spectrometer 120. However, it is contemplated that a separate processor based system may also be used to control the mass spectrometer 120, including a processor-based system incorporated into the mass spectrometer 120. Further, the results produced by the mass spectrometer 120 may be passed to the processor-based system 150 for processing, as discussed in detail below. While a direct connection between the mass spectrometer 120 and the processor-based system 150 is illustrated in FIG. 1, it is also contemplated that the results may be passed to the processor-based 150 system through a network (including, but not limited to, a local or a public network) or that the results may be passed through an additional peripheral device (not shown) such as an amplifier. Additionally, it is contemplated that the results may be saved to a storage medium, such as a floppy disk or CD-ROM and transferred to the processor-based system 150.

The I/O interface 151 may also be coupled to one or more input devices 130 including, but not limited to, user input devices such as a computer mouse, a keyboard, a touch-screen, a track-ball, a microphone (for a processor-based system having speech recognition capabilities), a bar-code or other type of scanner, or any of a number of other input devices capable of permitting input to be entered into the processor-based system 150.

Additionally, the I/O interface 151 may be coupled to at least one display 140 for displaying information to a user of the processor-based system 150. Numerous types of displays may be used in connection with the present invention depending on the type of information to be displayed. In one embodiment, display 140 may be a monitor, such as an LCD display or a cathode ray tube (“CRT”). Alternatively, the display may be a touch-screen display, an electroluminescent display or any other display that may be configured to display information to a user of processor-based system 150. It should also be realized that the mass spectrometer 120 may utilize display 140 or it may include its own display.

The I/O interface 151 may be coupled to a processor 153 via a bus 152. The processor 153 may be any type of processor configured to execute one or more application programs, for example. As used herein, the term application program is intended to have its broadest meaning and should include any type of software. Moreover, numerous applications are possible and the present invention is not intended to be limited by the type of application programs being executed or run by processor 153.

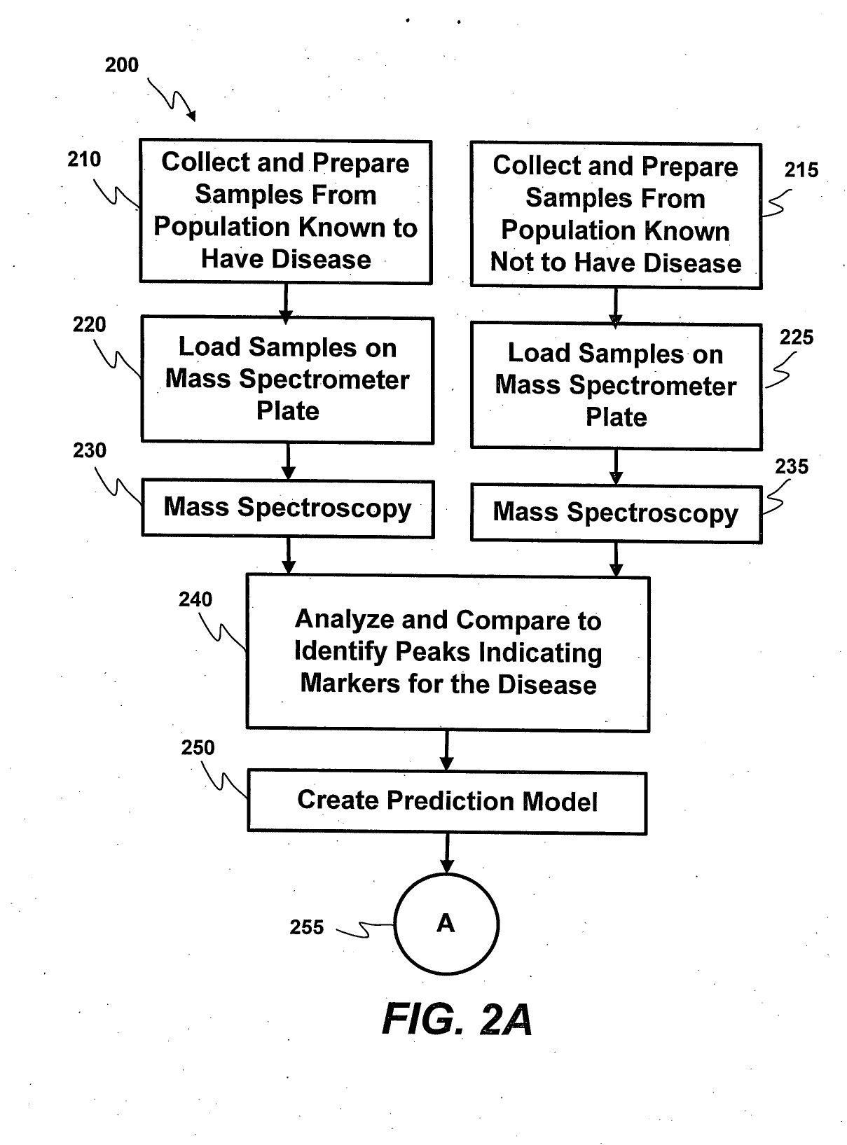

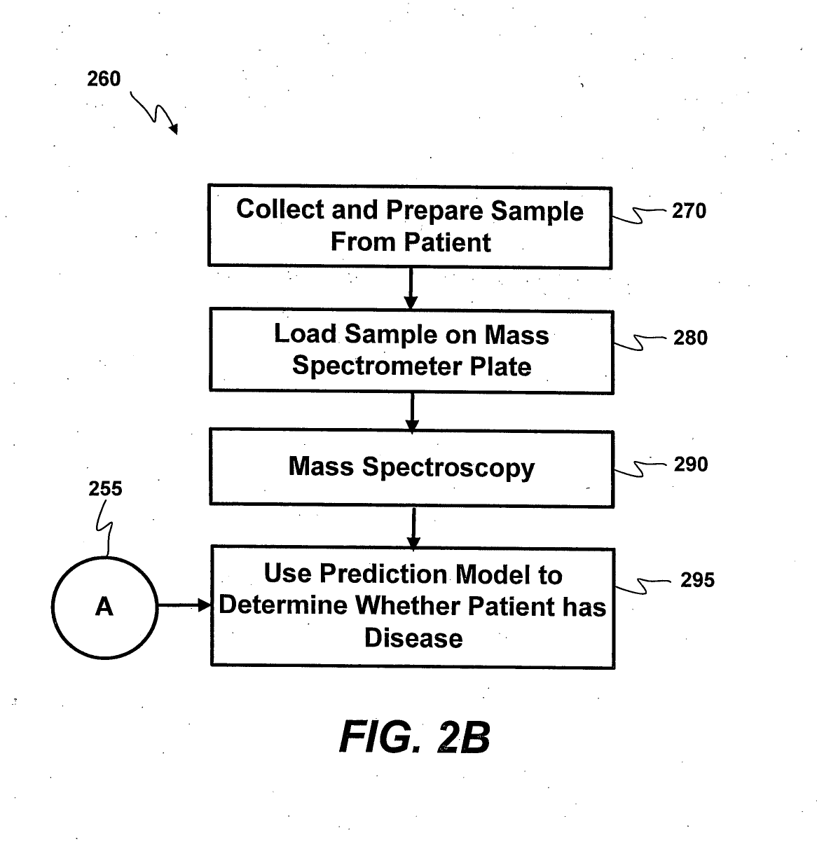

Further, processor 153 maybe coupled to a memory 155 via a bus 154. Memory 155 may be any type of a memory device including, but not limited to, volatile or non-volatile processor-readable media such as any magnetic, solid-state or optical storage media. Processor 153 may be configured to execute software code stored on memory 155 including software code for performing the functions of the processor 153. According to one embodiment of the present invention, memory 155 includes software code, which may be read by the processor, for instructing the processor 153 to execute the methods according to the present invention discussed in detail below with reference to FIGS. 2A and 2B.

FIGS. 2A and 2B show a method of predicting disease according to one embodiment of the present invention. As illustrated in FIG. 2A, the present invention may include a method 200 for creating a prediction model, which may be used in the detection of a specific type of disease, as discussed below. While specific examples of the present invention discussed below may reference the prediction of specific diseases, it should be realized that the present invention is not meant to be limited to any particular disease. In fact, the present invention is applicable to any disease that may show a difference in the detection of specific mass-ion peaks in mass spectra of patients having the disease compared to those of normal patients. Exemplary diseases may include, but are not limited to, cancers of the respiratory, gastrointestinal, renal, CNS, endocrine and blood systems or any other diseases or disease processes (e.g. necrosis, apoptosis) in which there are potential alterations in molecules contained in biological fluid (e.g. blood and blood derivatives, urine, cerebral spinal fluid, sputum, lavage). Such biological molecules may include, but are not limited to, macromolecules such -as polypeptides, proteins, nucleic acids, enzymes, DNA, RNA, polynucleotides, oligonucleotides, carbohydrates, oligosaccharides, polysaccharides, fragments of biological macromolecules (e.g. nucleic acid fragments, peptide fragments, and protein fragments), complexes of biological macromolecules (e.g. nucleic acid complexes, protein-DNA complexes, receptor-ligand complexes, enzyme-substrate, enzyme inhibitors, peptide complexes, protein complexes, carbohydrate complexes, and polysaccharide complexes), small biological molecules such as amino acids, nucleotides, nucleosides, sugars, steroids, lipids, metal ions, drugs, hormones, amides, amines, carboxylic acids, vitamins and coenzymes, alcohols, aldehydes, ketones, fatty acids, porphyrins, carotenoids, plant growth regulators, phosphate esters and nucleoside diphospho-sugars, synthetic small molecules such as pharmaceutically or therapeutically effective agents, monomers, peptide analogs, steroid analogs, inhibitors, mutagens, carcinogens, antimitotic drugs, antibiotics, ionophores, antimetabolites, amino acid analogs, antibacterial agents, transport inhibitors, surface-active agents (surfactants), mitochondrial and chloroplast function inhibitors, electron donors, carriers and acceptors, synthetic substrates for proteases, substrates for phosphatases, substrates for esterases and lipases and protein modification reagents; and synthetic polymers, oligomers, and copolymers. Additionally, any suitable mixture or combination of the substances mentioned above may also be included in the biological samples.

As shown in FIG. 2A at step 210, biological samples may be collected and prepared for mass spectrometry from a population having a clinically diagnosed disease. Likewise, at step 215, biological samples may be collected and prepared for mass spectrometry from a population known not to have the specific disease. Any type of biological sample may be used including, but not limited to, soft and hard tissue (e.g., from biopsies), blood, serum, plasma, nipple aspirate, urine, tears, saliva, cells, organs, semen, feces, and the like. The population may include any number of individual organisms and a sample may be collected from each individual in the population. One of ordinary skill in the art will realize that the size of the population used for the creation of the prediction model may be dependent upon the desired accuracy of the prediction model.

While the examples discussed below reference samples taken from human beings, it is contemplated that the present invention may be utilized for the prediction of disease in, or caused by, any type of organism including, but not limited to, eukaryotic, prokaryotic, or viral organisms. The collection of the samples may be performed using any conventional methods for extracting biological samples from these organisms, as will be known to one of ordinary skill in the art.

It should be noted that the type of samples used for the prediction of a specific disease may be dependent on the type of disease for which a prediction model is to be created. For example, if it is desired to create a prediction model for the prediction of bladder cancer in humans, it may be desirable to collect urine samples from a number of humans known to have bladder cancer at step 210 and to collect urine samples from a number of humans known not to have bladder cancer at step 215.

Once the samples have been collected, they may be prepared for mass spectrometry using any conventional method for preparation including, but not limited to, filtration, extraction, centrifugation, purification, ion-exchange or size chromatography, precipitation, buffer exchange or dilution. The samples may then be prepared for evaluation by a mass spectrometer by making a matrix of samples. An appropriate matrix may be chosen according to the appropriate mass/ion species of interest. At steps 220 and 225, the matrix and the samples may then be loaded onto a mass spectrometer plate associated with the mass spectrometer to be used for the analysis.

Each set of samples may then be placed in a mass spectrometer at steps 230 and 235. While it is contemplated that any conventional type of mass spectrometer may be utilized, as discussed above, one embodiment of the present invention utilizes matrix-assisted laser desorption/ionization—time of flight (“MALDI-TOF”) mass spectrometer. As known to one of ordinary skill in the art, MALDI-TOF is a mass spectrometry technique in which a co-precipitate of an ultraviolet light absorbing matrix and a biomolecule may be irradiated by a nanosecond laser pulse. Most of the laser energy may be absorbed by the matrix, which may prevent unwanted fragmentation of the biomolecule. The spectrometer may operate on the principle that when a temporally and spatially well defined group of ions of differing mass/charge (m/z) ratios are subjected to the same applied electric field and allowed to drift in a region of constant electric field, they may traverse this region in a time which depends upon their m/z ratios. The ionized biomolecules in the sample may then be accelerated in an electric field and enter the flight tube (under vacuum) of the spectrometer.

During the flight in this tube, the different molecules of the sample may be separated according to their mass to charge ratio and may reach the detector of the spectrometer at different times. Again, the time an ion takes to pass down the tube depends on the ratio of its charge to its mass—its mass/charge ratio, m/z. The spectrometer may observe the time of flight of the ion as it travels from anode or cathode to detector.

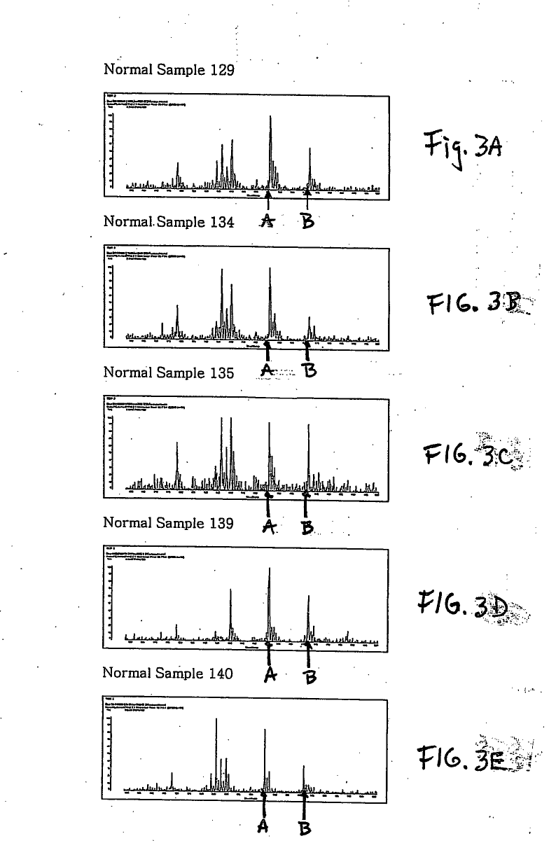

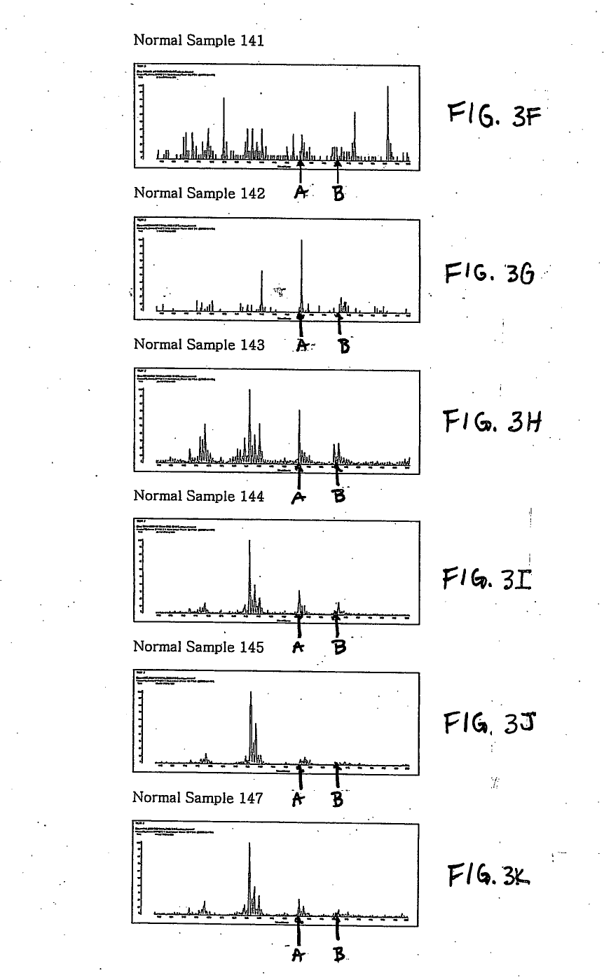

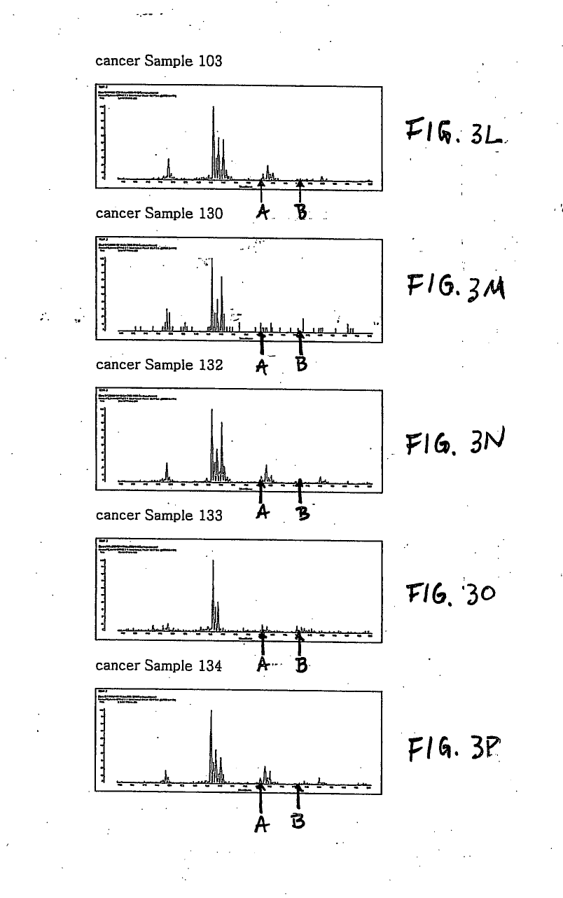

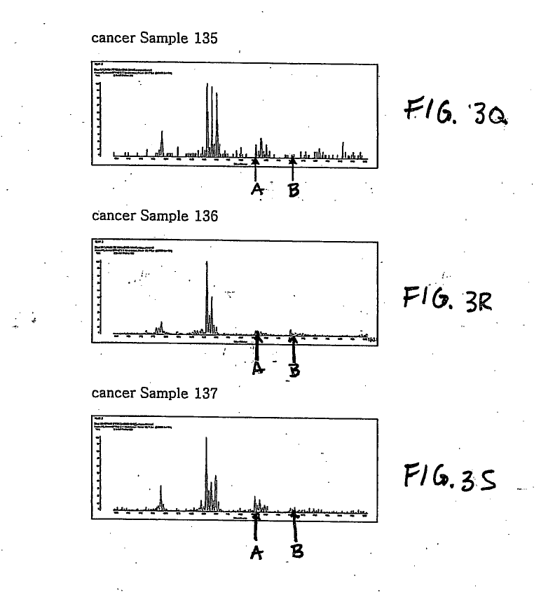

Generally, the spectrometer's software may convert the time of flight of the ion to an m/z ratio. The spectrometer may then output the number of ions in the sample having this m/z ratio. While, for clarity, FIGS. 3A-5F of the present invention illustrate the output of the spectrometer as a mass spectrum showing the number of ions in a sample having a specific m/z ratio, it is contemplated that any type of output may be provided by the spectrometer. This may include the output of “raw data” to processor-based system 150, a spectrograph, a spreadsheet or any other conventional types of data output.

Once mass spectrometry of the samples is completed (steps 230 and 235), the processor-based system 150 may then receive the results at step 240 for analysis and comparison. In one embodiment of the present invention, processor-based system 150 may utilize a spreadsheet or other commonly known statistical package including, but not limited to, SAS or SPSS for analyzing the data. As discussed in detail below, a prediction model may then be created (step 250) which may then be stored in memory and accessed for use in the prediction of disease (step 255).

The analysis and comparison of the spectrometry data at step 240 may be performed by identifying a number of optimal features in the data and performing a statistical analysis to identify a predictor in the spectrometry data which may be used for the prediction of a disease, and as illustrated in the examples below. As will be known to one of ordinary skill in the art, the present invention may utilize any appropriate statistical analysis including, but not limited to, linear discriminant analysis (including Fisher's linear discriminant analysis), variance analysis, regression analysis, principal component analysis, factor analysis or discriminant correspondence analysis. In one embodiment, feature extraction may be performed prior to the statistical analysis in order to further select top spectral weight values.

According to one, embodiment of the present invention, linear discriminant analysis (“LDA”) may be performed in any conventional manner for applying LDA to data output from a mass spectrometer, as known to one of ordinary skill in the art. This may include first generating a model having one or more estimated parameter values associated with a conditional distribution of the data from the samples collected and prepared at step 210. It should be noted that in the model, predictor or covariate values may identify spectral weight values associated with the clinically diagnosed disease. The estimated parameter values may also be modified by identifying one or more true positives and false positives among them, as will be known to one of ordinary skill in the art.

The data from the samples collected and prepared at step 215 may then be compared to the model to determine which estimated parameter may be the predictor spectral weight value associated with the clinically diagnosed disease. This may be accomplished by determining which peaks are present in the samples collected and prepared at step 215 and not present in the samples collected and prepared at step 210, or vice versa. Based on the results of the linear discriminant analysis, a prediction model may be created at step 250 which may identify which spectral weight values are associated with the specific disease.

For example, and as discussed below in the Examples, the statistical analysis may identify that a particular spectral peak in a normal patient's spectrometry data may not be present in the spectrometry data of a patient having a particular disease. Thus, the method of the present invention described with reference to FIG. 2A may be used to identify the specific spectral peak or peaks which are not present in a patient having the particular disease. As such, the prediction model may be used to look at the spectrometry data of a patient to look for the presence, or non-presence, of that particular spectral peak to determine whether the patient has the particular disease.

In one embodiment of the present invention, it may be desirable to test the prediction model before it is used to predict disease in patients. This process may involve utilizing the steps described below with reference to FIG. 2B by using a sample from a patient known to have, or known not to have, the specific disease for which the prediction model is to be used. Once the prediction model is validated, it may be used to predict the presence of the disease in patients, as described below with reference to FIG. 2B.

As illustrated in FIG. 2B, the present invention may include a method 260 for determining whether a patient has a particular disease by using a prediction model created according to the method discussed with reference to FIG. 2A. At step 270, a biological sample may be collected from a patient in the same manner as the collection of samples from the population discussed above. It should again be noted that the type of sample and the type of patient should correspond to the type of sample and the type of organisms in the population used in the creation of the prediction model. At step 280, the sample from the patient may be loaded on the mass spectrometer plate, in the same manner as discussed above, and the mass spectrometer may be used to analyze the sample in the same manner as discussed above.

In the method 260, it may not be known whether the patient has a particular disease. Thus, a prediction model 255 for that particular disease, created in the manner discussed above, may be accessed at step 295 and used to determine whether the patient has the particular disease. This may involve utilizing the prediction model 255 to look for the presence or absence of a specific spectral peak or peaks in the patient's mass spectrum, which may be accomplished using any conventional method for analysis known to one of skill in the art. More particularly, this analysis may also include, but is not limited to, having a trained scientist compare the patient's mass spectra with that of the prediction model or having the comparison performed by a processor-based system. This method is illustrated in further detail with respect to the Examples discussed below.

As mentioned above, the following Examples 1-3 illustrate specific testing and analysis of sera using the methods of the present invention. One of ordinary skill in the art will realize that, while each of these examples is specific to a particular disease and testing situation, they are only being provided for illustrative purposes and are not meant to limit the scope and applicability of the present invention.

### EXAMPLE 1

The discussion below describes a specific lung cancer screening performed using the apparatus and methods according to the present invention discussed above. MALDI-TOF was used to generate a spectra sample data set representing distinct m/z ion peak distribution patterns in serum. Linear discrimination analysis was then used to create a prediction model, as discussed below. In order to perform the linear discrimination analysis, sera was collected from (a) patients without a history of cancer (healthy controls) and (b) patients with histologically confirmed lung cancer.

The sera were prepared for evaluation by the mass spectrometer by making a matrix of serum samples. The mass spectrometer matrix contained saturated alpha-cyano-4-hydroxycinnamic acid in 50% acetonitrile-0.05% trifluoroacetic acid (TFA). The sera were diluted 1:1000 in 0.1% n-Octyl β-D-Glucopyranoside. 0.5 μL of the matrix was placed on each defined area of a sample plate with 384 defined areas and 0.5 μL serum from each individual was added to a defined area followed by air drying. Samples and their locations on the sample plates were recorded for accurate data interpretation. An Axima-CFR MALDI-TOF mass spectrometer manufactured by Kratos Analytical Inc. was used. The instrument was set to the following specifications: tuner mode, linear; mass range, 0 to about 5,000; laser power, 90; profile, 100; and shots per spot, 5. The output of the mass spectrometer was stored in computer storage in the form of a sample data set.

FIGS. 3A-3S are mass spectra illustrating specific m/z ratios from 400 to 500 versus the percentage of intensity of that m/z ratio in the specific sample. A comparison between normal sera data and lung cancer data is illustrated in FIGS. 3A to 3S, with data from normal samples illustrated in FIGS. 3A to 3K and data from lung cancer samples illustrated in FIGS. 3L to 3S.

As illustrated in FIGS. 3A to 3S, when the mass spectra profiles were compared on a fixed range, a substantial difference was found between normal sera and lung cancer sera at point A and point B. As shown in the figures, point A corresponds to an m/z ratio of 456 and point B corresponds to an m/z ratio of 472. As also shown in the figures, the mass spectra of normal sera showed peaks at points A and B while the mass spectra of lung cancer sera had substantially no peaks at points A and B.

In the case of normal sera as shown in FIGS. 3A-3K, ten of eleven samples showed peaks at point A (e.g., FIGS. 3A-3I and 3K). Further, six samples of eleven samples show peaks at point B (e.g., FIGS. 3A-3E and 3H). However, in the case of lung cancer sera, as shown in FIGS. 3L-3S, none of the samples show peaks in the points A and B. These results are summarized in the table below:

| | Mass/Charge Ratio | |
|---|---|---|
| Sera Group | 456 | 472 |
| No. of samples with peaks in Normal Sera | 10/11 | 6/11 |
| No. of samples with peaks in Lung Cancer Sera | 0/8 | 0/8 |

As such, one of ordinary skill in the art will realize that the presence of peaks at points A and B may indicate that a patient does not suffer from lung cancer. However, the non-presence of peaks at points A and B may indicate that the patient suffers from lung cancer, or may indicate the presence of tumors in the patient's body. As such, these results may be used to determine whether an unknown patient suffers from lung cancer, or is at risk for developing lung cancer.

### EXAMPLE 2

The discussion below describes a specific pancreatic cancer screening performed using the apparatus and methods according to the present invention discussed above. MALDI-TOF was used to generate a spectra sample data set representing distinct m/z ion peak distribution patterns in serum. Linear discrimination analysis was then used to create a prediction model, as discussed below. In order to perform the linear discrimination analysis, sera was collected from (a) patients without a history of cancer (healthy controls) and (b) patients with histologically confirmed pancreatic cancer.

The sera were prepared for evaluation by the mass spectrometer by making a matrix of serum samples. The mass spectrometer matrix contained saturated alpha-cyano-4-hydroxycinnamic acid in 50% acetonitrile-0.05% trifluoroacetic acid (TFA). The sera were diluted 1:1000 in 0.1% n-Octyl β-D-Glucopyranoside. 0.5 μL of the matrix was placed on each defined area of a sample plate with 384 defined areas and 0.5 μL serum from each individual was added to a defined area followed by air drying. Samples and their locations on the sample plates were recorded for accurate data interpretation. An Axima-CFR MALDI-TOF mass spectrometer manufactured by Kratos Analytical Inc. was used. The instrument was set to the following specifications: tuner mode, linear; mass range, 0 to about 5,000; laser power, 90; profile, 100; and shots per spot, 5. The output of the mass spectrometer was stored in computer storage in the form of a sample data set.

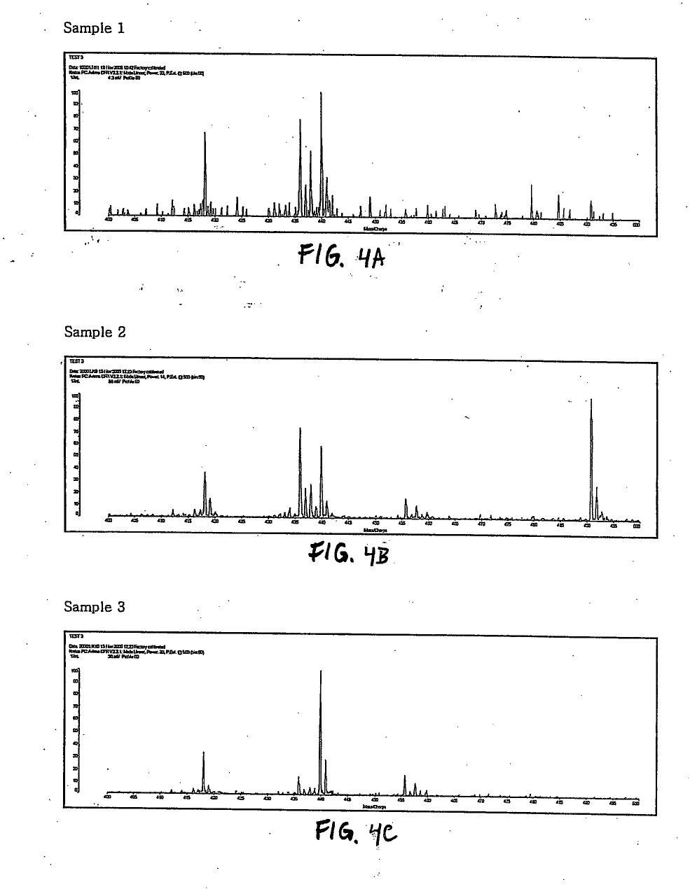

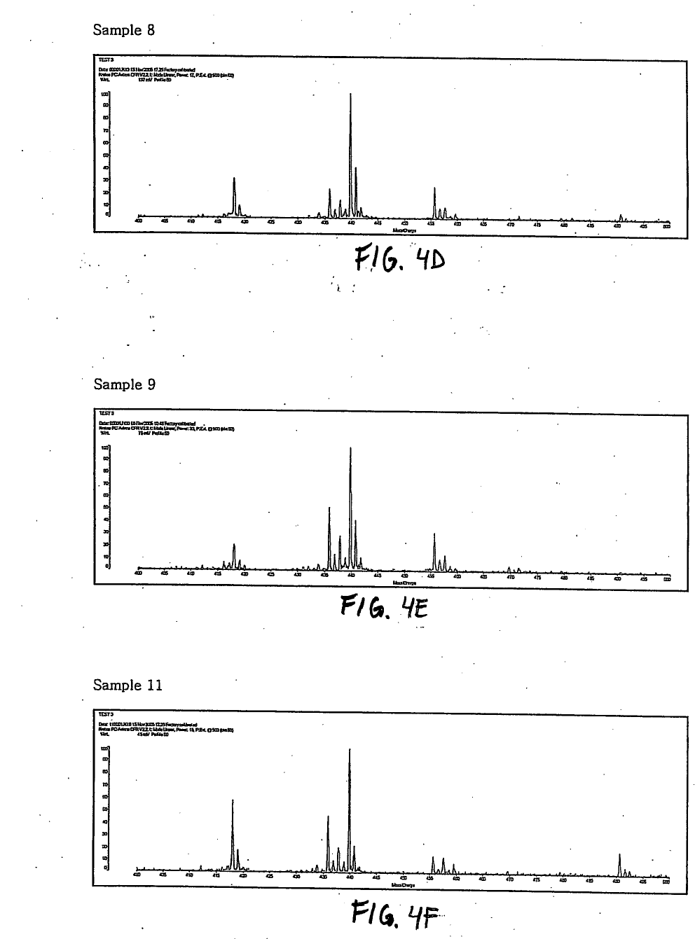

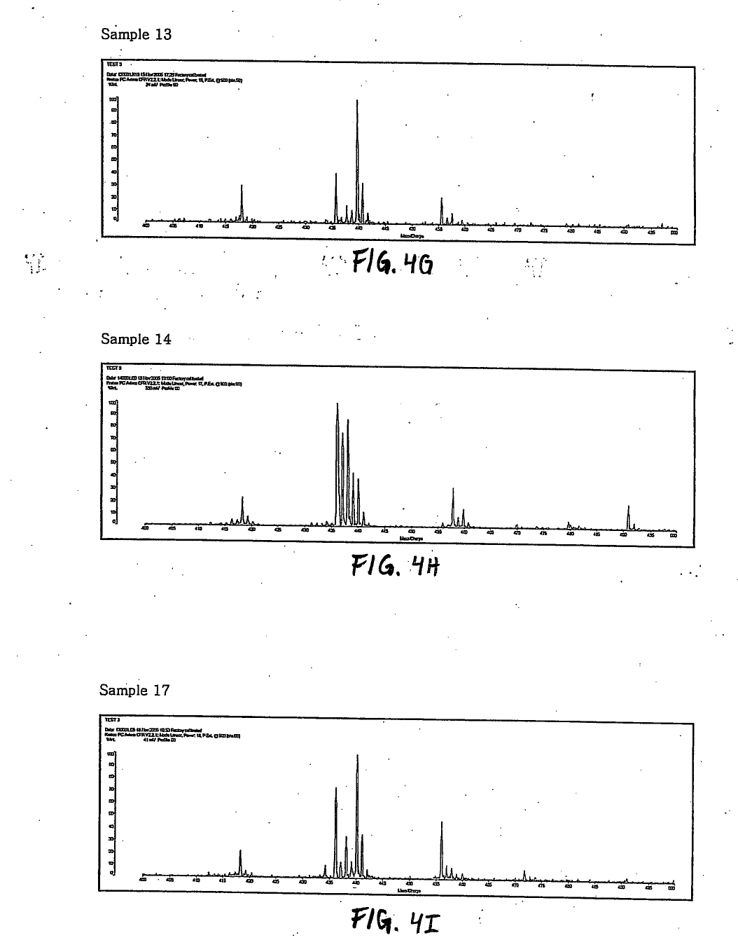

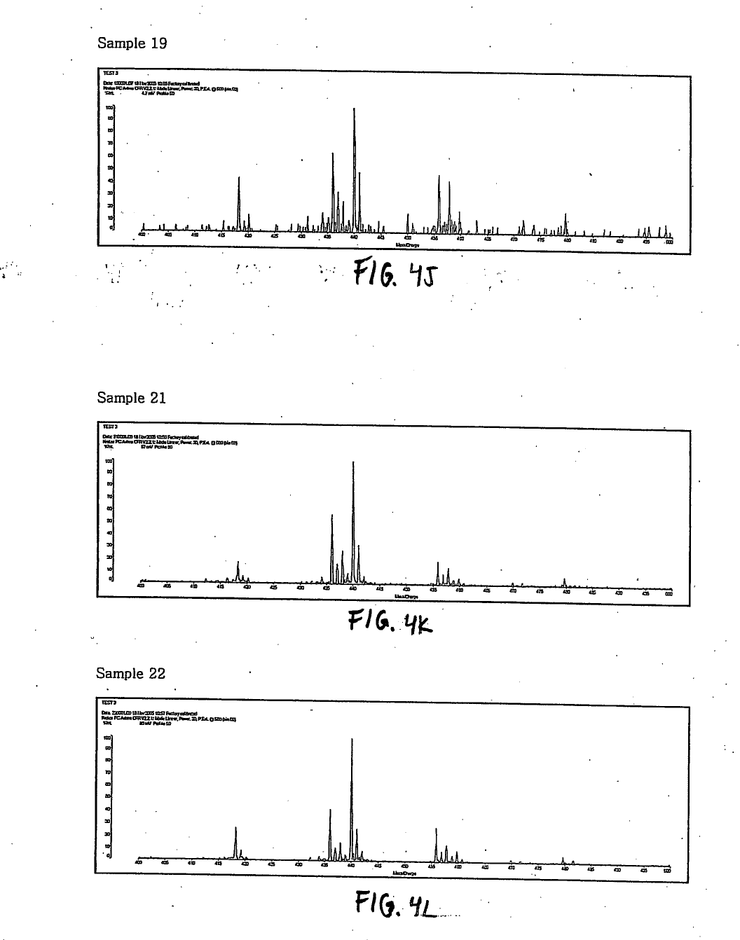

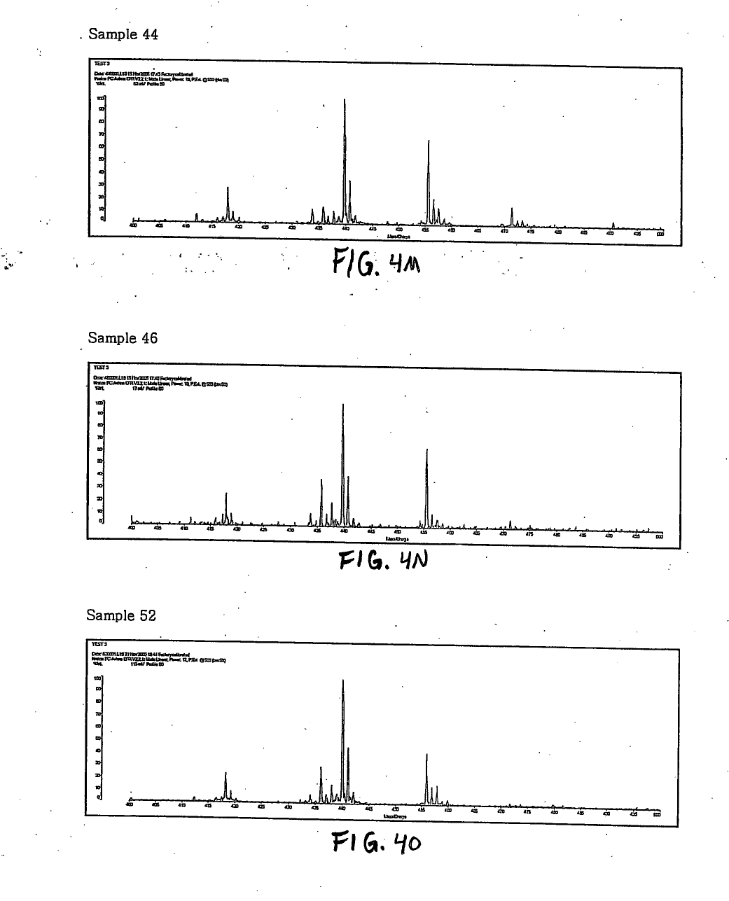

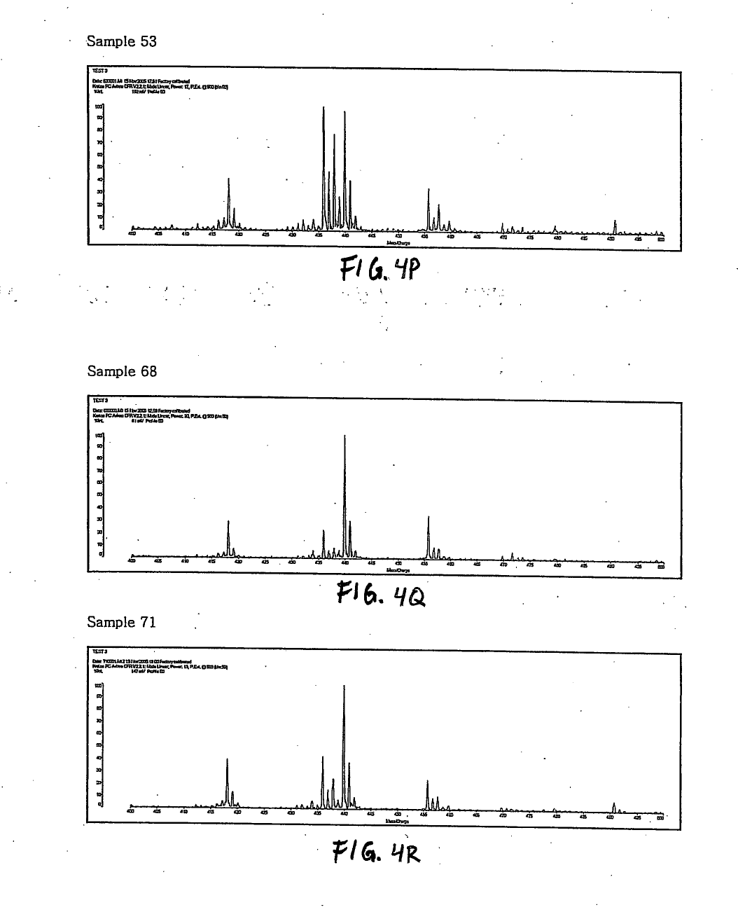

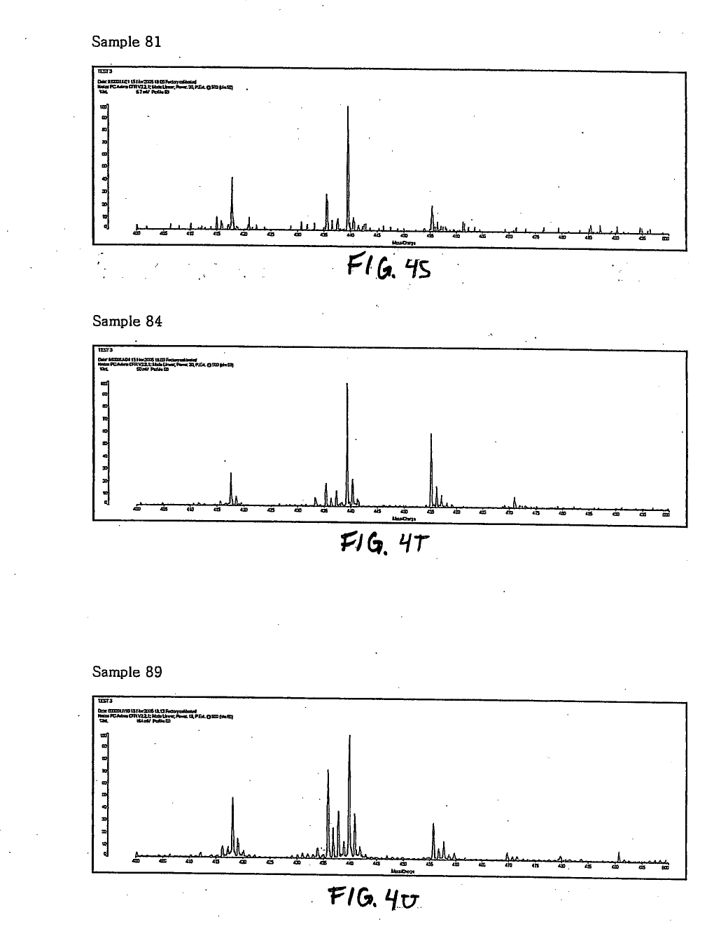

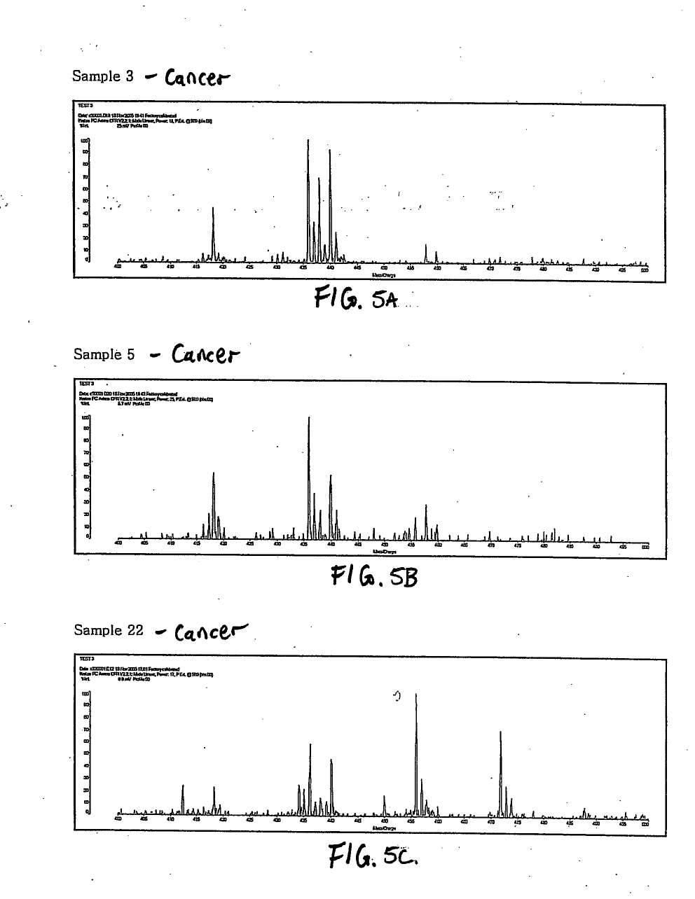

An analysis of the data described in this Example reveals that, while the distinctive peaks in mass spectra of normal samples are linked as illustrated in the Examples above (that is, the peaks will all increase or decrease in percentage together, or will all be present or not present), the distinctive peaks in cancer samples appear to be disassociated. With respect to pancreatic cancer, distinctive peaks associated with the cancer may be present at mass/ion ratios of 456 and 472. However, as one of ordinary skill in the art will realize from analyzing FIGS. 4A to 4U, these peaks are not linked. That is, one peak may appear while the other peak does not appear in individual pancreatic cancer samples.

### EXAMPLE 3

The discussion below describes a specific bladder cancer screening performed using the apparatus and methods according to the present invention discussed above. MALDI-TOF was used to generate a spectra sample data set representing distinct m/z ion peak distribution patterns in serum. Linear discrimination analysis was then used to create a prediction model, as discussed below. In order to perform the linear discrimination analysis, sera were collected from (a) patients without a history of cancer (healthy controls) and (b) patients with histologically confirmed bladder cancer.

The sera were prepared for evaluation by the mass spectrometer by making a matrix of serum samples. The mass spectrometer matrix contained saturated alpha-cyano-4-hydroxycinnamic acid in 50% acetonitrile-0.05% trifluoroacetic acid (TFA). The sera were diluted 1:1000 in 0.1% n-Octyl β-D-Glucopyranoside. 0.5 μL of the matrix was placed on each defined area of a sample plate with 384 defined areas and 0.5 μL serum from each individual was added to a defined area followed by air drying. Samples and their locations on the sample plates were recorded for accurate data interpretation. An Axima-CFR MALDI-TOF mass spectrometer manufactured by Kratos Analytical Inc. was used. The instrument was set to the following specifications: tuner mode, linear; mass range, 0 to about 5,000; laser power, 90; profile, 100; and shots per spot, 5. The output of the mass spectrometer was stored in computer storage in the form of a sample data set.

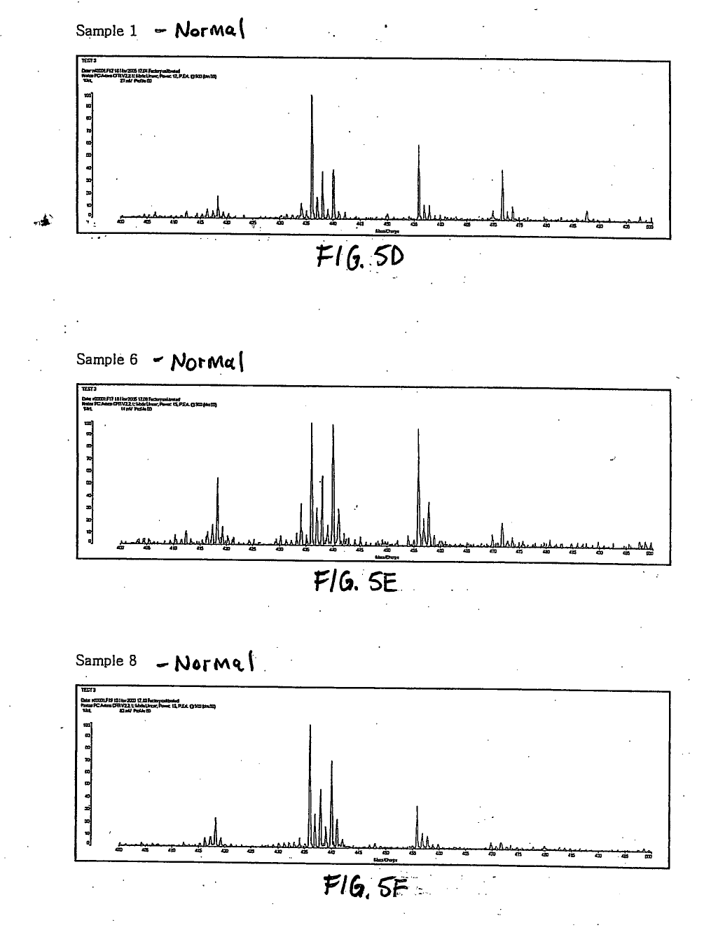

As with the lung and pancreatic cancer screenings discussed above with respect to Examples 1 and 2, one of ordinary skill in the art will realize that the mass spectra illustrated in FIGS. 5A to 5F (FIGS. 5A to 5C are mass spectra of samples known to have bladder cancer and FIGS. D to 5F are normal mass spectra) illustrate distinctive spectral peaks whose non-presence illustrates the presence of bladder cancer. As such, these results may then be used to determine whether an unknown patient suffers from bladder cancer, or is at risk for developing bladder cancer.

An analysis of the data described in this Example reveals that distinctive peaks at mass/ion ratios of 456 and 472 in mass spectra of normal samples (FIGS. 5D to 5F) are linked as illustrated in the Examples above (that is, the peaks will all increase or decrease in percentage together, or will all be present or not present). However, the distinctive peaks in cancer samples (FIGS. 5A to 5C) appear to be disassociated, as discussed in the preceding Example 2. That is, one peak may appear while the other peak does not appear in individual pancreatic cancer samples.

### EXAMPLE 4

Peaks generated in accordance with the present invention (as described above) were further characterized for peak intensity using linear discrimination models for correlation with lung cancer, as show in Tables 1-3 below. Three peaks at mass/ion ratios of 440, 456 and 472 were analyzed to determine if peak intensity cutoff values could be determined and whether the peak was suitable (specificity and sensitivity) as a biomarker. Table 1 shows the number of sera samples collected from normal patients (e.g., those not having lung cancer) and cancer patients at each peak intensity value from 5% to 100% for the peak at a mass/charge ratio of 440. Table 2 shows the intensity values from 0% to 100% for the peak at amass/charge ratio of 456 and Table 3 shows the intensity values from 1% to 100% for the peak at a mass/charge ratio of 472. Tables 4 and 5 show the use of the mass spectra ratios of 440/456 and 440/472, respectively, for further analysis with linear discrimination models.

TABLE 1
Listing of mass spec peak height at 440
to compare normal and cancer samples

| | Korean Normal | | Cancer Samples | | | |
|---|---|---|---|---|---|---|
| | Sample | | Korea | | China | |
| Peak height | Sample | | Sample | | Sample | |
| at 440 | Count | Percent | Count | Percent | Count | Percent |
| 5 | 1 | 1.61 | — | — | — | — |
| 10 | 2 | 3.23 | — | — | — | — |
| 15 | 1 | 1.61 | — | — | — | — |
| 20 | 3 | 4.84 | — | — | — | — |
| 25 | 2 | 3.23 | — | — | — | — |
| 30 | 4 | 6.45 | — | — | — | — |
| 35 | 1 | 1.61 | — | — | — | — |
| 40 | 6 | 9.68 | 1 | 1.69 | — | — |
| 45 | 2 | 3.23 | — | — | — | — |
| 50 | 9 | 14.52 | — | — | — | — |
| 55 | 1 | 1.61 | — | — | — | — |
| 60 | 8 | 12.90 | — | — | — | — |
| 65 | 2 | 3.23 | — | — | — | — |
| 70 | 7 | 11.29 | — | — | — | — |
| 75 | 2 | 3.23 | — | — | — | — |
| 80 | 2 | 3.23 | — | — | — | — |
| 90 | 3 | 4.84 | — | — | — | — |
| 100 | 6 | 9.68 | 58 | 98.31 | 53 | 100 |

Nearly all (111/112) of the cancer observations are at a single value, that is 100. This reflects the upper limit of maximum intensity percentage of 100. In this case, it leads to a simple decision rule; “call the sample Cancer if the value is 100; otherwise, call it non-Cancer.” This simple rule has sensitivity of 111/112>99% and specificity of 56/62=90%.

TABLE 2
Listing of mass spec peak height at 456
to compare normal and cancer samples

| | Korean Normal | | Cancer Samples | | | |
|---|---|---|---|---|---|---|
| | Samples | | Korea | | China | |
| Peak height | Sample | | Sample | | Sample | |
| at 456 | Count | Percent | Count | Percent | Count | Percent |
| 0 | — | — | — | — | 1 | 2.04 |
| 1 | — | — | 1 | 1.72 | — | — |
| 5 | — | — | — | — | 4 | 8.16 |
| 7 | • | — | — | — | 1 | 2.04 |
| 10 | 1 | 1.59 | 19 | 33.76 | 17 | 34.69 |
| 15 | — | — | 13 | 22.41 | 9 | 18.37 |
| 20 | — | — | 14 | 24.14 | 11 | 22.45 |
| 25 | — | — | 4 | 6.90 | — | — |
| 30 | — | — | 2 | 3.45 | 3 | 6.12 |
| 35 | 1 | 1.59 | 1 | 1.72 | — | — |
| 40 | — | — | 3 | 5.17 | 1 | 2.04 |
| 45 | — | — | 1 | 1.72 | — | — |
| 50 | 1 | 1.59 | — | — | 2 | 4.08 |
| 60 | 2 | 3.17 | — | — | — | — |
| 70 | 1 | 1.59 | — | — | — | — |
| 75 | 2 | 3.17 | — | — | — | — |
| 80 | 5 | 7.94 | — | — | — | — |
| 90 | 2 | 3.17 | — | — | — | — |
| 100 | 48 | 76.19 | — | — | — | — |

These columns are only for the peak at 456, displaying all three relevant samples. No digit preference is visible here. In the normal samples, 48/63 observations (76%) are at 100. Thus, the following rule may be inferred: “greater or equal to 50 is normal, while less than 50 is cancer.” This rule has specificity 61/63=97% and sensitivity 100%.

TABLE 3
Listing of mass spec peak height at 472
to compare normal and cancer samples

| | Korean Normal | | Cancer Samples | | | |
|---|---|---|---|---|---|---|
| | Samples | | Korea | | China | |
| Peak height | Sample | | Sample | | Sample | |
| at 472 | Count | Percent | Count | Percent | Count | Percent |
| 1 | — | — | 50 | 86.21 | 48 | 90.57 |
| 3 | — | — | 2 | 3.45 | — | — |
| 5 | 1 | 1.61 | 2 | 3.45 | 5 | 9.43 |
| 10 | — | — | 3 | 5.17 | — | — |
| 20 | 1 | 1.61 | — | — | — | — |
| 25 | 2 | 3.23 | — | — | — | — |
| 30 | 4 | 6.45 | — | — | — | — |
| 35 | 2 | 3.23 | — | — | — | — |
| 40 | 10 | 16.13 | — | — | — | — |
| 45 | 1 | 1.61 | — | — | — | — |
| 50 | 9 | 14.52 | — | — | — | — |
| 55 | 1 | 1.61 | — | — | — | — |
| 60 | 9 | 14.52 | — | — | — | — |
| 65 | 2 | 3.23 | — | — | — | — |
| 70 | 3 | 4.84 | — | — | — | — |
| 75 | 2 | 3.23 | — | — | — | — |
| 80 | 3 | 4.84 | — | — | — | — |
| 90 | 1 | 1.61 | — | — | — | — |
| 100 | 11 | 17.74 | — | — | — | — |

These columns are only for the peak at 472. Digit preference is apparent in the normal sample. Nearly all the cancer samples are at peak height of 1. Again, there is a nearly perfect decison rule: “greater or equal to 20 is normal, while less than 20 is cancer.” This rule has a specificity of 60/62=97% and a sensitivity of 110/110=100%.

TABLE 4
Listing of mass spec ratios of 440/456
to compare normal and cancer samples

| | Korean Normal | | Cancer Samples | | | |
|---|---|---|---|---|---|---|
| | Samples | | Korea | | China | |
| Peak height | Sample | | Sample | | Sample | |
| at 440/456 | Count | Percent | Count | Percent | Count | Percent |
| 0.05 | 1 | 1.61 | — | — | — | — |
| 0.19 | 1 | 1.61 | — | — | — | — |
| 0.20 | 3 | 4.84 | — | — | — | — |
| 0.25 | 1 | 1.61 | — | — | — | — |
| 0.30 | 2 | 3.23 | — | — | — | — |
| 0.33 | 1 | 1.61 | — | — | — | — |
| 0.35 | 1 | 1.61 | — | — | — | — |
| 0.40 | 6 | 9.68 | — | — | — | — |
| 0.42 | 1 | 1.61 | — | — | — | — |
| 0.44 | 1 | 1.61 | — | — | — | — |
| 0.45 | 2 | 3.23 | — | — | — | — |
| 0.50 | 8 | 18.90 | — | — | — | — |
| 0.55 | 1 | 1.61 | — | — | — | — |
| 0.57 | 1 | 1.61 | — | — | — | — |
| 0.60 | 8 | 12.90 | — | — | — | — |
| 0.63 | 1 | 1.61 | — | — | — | — |
| 0.65 | 2 | 3.23 | — | — | — | — |
| 0.70 | 7 | 11.29 | — | — | — | — |
| 0.75 | 1 | 1.61 | — | — | — | — |
| 0.80 | 2 | 3.23 | — | — | — | — |
| 0.90 | 3 | 4.84 | — | — | — | — |
| 1.00 | 3 | 4.84 | — | — | — | — |
| 1.25 | 3 | 4.84 | — | — | — | — |
| 1.43 | 1 | 1.61 | — | — | — | — |
| 1.67 | 1 | 1.61 | — | — | — | — |
| 2.00 | — | — | — | — | 2 | 4.17 |
| 2.22 | — | — | 1 | 1.72 | — | — |
| 2.50 | — | — | 3 | 5.17 | 1 | 2.08 |
| 2.86 | — | — | 1 | 1.72 | — | — |
| 3.33 | — | — | 2 | 3.45 | 3 | 6.25 |
| 4.00 | — | — | 5 | 8.62 | — | — |
| 5.00 | — | — | 14 | 24.14 | 11 | 22.92 |
| 6.67 | — | — | 13 | 22.41 | 9 | 18.75 |
| 10.00 | — | — | 18 | 31.03 | 17 | 35.42 |
| 14.29 | — | — | — | — | 1 | 2.08 |
| 20.00 | — | — | — | — | 4 | 8.33 |
| 100.00 | — | — | 1 | 1.72 | — | — |

Even with this calculated quantity, the impact of digit preference is visible. Again, there is a nearly perfect decision rule: “greater or equal to 2 is normal, while less than 2 is cancer.”

TABLE 5
Listing of mass spec ratios of 440/472
to compare normal and cancer samples

| | Korean Normal | | Cancer Samples | | | |
|---|---|---|---|---|---|---|
| | Sample | | Korea | | China | |
| Ratio of | Sample | | Sample | | Sample | |
| 440/472 | Count | Percent | Count | Percent | Count | Percent |
| 0.07 | 1 | 1.61 | — | — | — | — |
| 0.10 | 1 | 1.61 | — | — | — | — |
| 0.15 | 1 | 1.61 | — | — | — | — |
| 0.20 | 2 | 3.23 | — | — | — | — |
| 0.30 | 3 | 4.84 | — | — | — | — |
| 0.33 | 1 | 1.61 | — | — | — | — |
| 0.38 | 1 | 1.61 | — | — | — | — |
| 0.40 | 2 | 3.23 | — | — | — | — |
| 0.42 | 1 | 1.61 | — | — | — | — |
| 0.44 | 1 | 1.61 | — | — | — | — |
| 0.50 | 1 | 1.61 | — | — | — | — |
| 0.62 | 1 | 1.61 | — | — | — | — |
| 0.63 | 2 | 3.23 | — | — | — | — |
| 0.67 | 1 | 1.61 | — | — | — | — |
| 0.70 | 1 | 1.61 | — | — | — | — |
| 0.71 | 1 | 1.61 | — | — | — | — |
| 0.75 | 2 | 3.23 | — | — | — | — |
| 0.83 | 1 | 1.61 | — | — | — | — |
| 0.90 | 1 | 1.61 | — | — | — | — |
| 0.91 | 1 | 1.61 | — | — | — | — |
| 0.92 | 1 | 1.61 | — | — | — | — |
| 0.93 | 2 | 3.23 | — | — | — | — |
| 1.00 | 1 | 1.61 | — | — | — | — |
| 1.07 | 1 | 1.61 | — | — | — | — |
| 1.11 | 1 | 1.61 | — | — | — | — |
| 1.13 | 1 | 1.61 | — | — | — | — |
| 1.17 | 2 | 3.23 | — | — | — | — |
| 1.20 | 3 | 4.84 | — | — | — | — |
| 1.25 | 1 | 1.61 | — | — | — | — |
| 1.30 | 1 | 1.61 | — | — | — | — |
| 1.38 | 1 | 1.61 | — | — | — | — |
| 1.40 | 2 | 3.23 | — | — | — | — |
| 1.50 | 5 | 8.06 | — | — | — | — |
| 1.67 | 2 | 3.23 | — | — | — | — |
| 1.80 | 1 | 1.61 | — | — | — | — |
| 1.88 | 1 | 1.61 | — | — | — | — |
| 2.00 | 2 | 3.23 | — | — | — | — |
| 2.33 | 1 | 1.61 | — | — | — | — |
| 2.50 | 1 | 1.61 | — | — | — | — |
| 2.80 | 1 | 1.61 | — | — | — | — |
| 2.86 | 2 | 3.23 | — | — | — | — |
| 3.33 | 2 | 3.23 | — | — | — | — |
| 4.00 | 1 | 1.61 | 1 | 1.72 | — | — |
| 5.00 | — | — | 1 | 1.72 | — | — |
| 10.00 | — | — | 2 | 3.45 | — | — |
| 20.00 | — | — | 2 | 3.45 | 5 | 9.43 |
| 33.33 | — | — | 2 | 3.45 | — | — |
| 100.00 | — | — | 50 | 86.21 | 48 | 90.57 |

For this table, digit preference is no longer visible. Nearly all the cancer samples are at one end of the scale. Again, there is a nearly perfect decision rule: “greater or equal to 4 is normal, while less than 4 is cancer.”

TABLE 6
The sum of peaks 456 and 472 as a potential
discriminator between cancer and normal.

| | Korean Normal | | Cancer Samples | | | |
|---|---|---|---|---|---|---|
| | Samples | | Korea | | China | |
| Ratio of | Sample | | Sample | | Sample | |
| 456 and 472 | Count | Percent | Count | Percent | Count | Percent |
| 15 | 1 | 1.61 | — | — | — | — |
| 50 | — | — | — | — | — | — |
| 65 | 1 | 1.61 | 1 | 1.72 | — | — |
| 75 | 2 | 3.23 | — | — | — | — |
| 80 | 3 | 4.84 | — | — | — | — |
| 85 | 3 | 4.84 | — | — | — | — |
| 90 | 1 | 1.61 | — | — | — | — |
| 95 | 4 | 6.45 | — | — | — | — |
| 100 | 6 | 9.68 | — | — | — | — |
| 101 | — | — | — | — | — | — |
| 103 | — | — | 50 | 86.21 | 48 | 90.57 |
| 105 | 2 | 3.23 | 2 | 3.45 | — | — |
| 110 | 6 | 9.68 | 2 | 3.45 | 5 | 9.43 |
| 115 | 3 | 4.84 | 2 | 3.45 | — | — |
| 120 | 5 | 8.06 | — | — | — | — |
| 125 | 1 | 1.61 | 1 | 1.72 | — | — |
| 130 | 9 | 14.52 | — | — | — | — |
| 135 | 3 | 4.84 | — | — | — | — |
| 140 | 5 | 8.06 | — | — | — | — |
| 145 | 1 | 1.61 | — | — | — | — |
| 150 | 3 | 4.84 | — | — | — | — |
| 155 | 1 | 1.61 | — | — | — | — |
| 160 | 1 | 1.61 | — | — | — | — |
| 175 | 1 | 1.61 | — | — | — | — |

Note:
This table displays the sum of peaks 456 and 472 as a potential discriminator between cancer and normal.

While the invention has been described with reference to certain exemplary embodiments thereof, those skilled in the art may make various modifications to the described embodiments of the invention without departing from the scope of the invention. The terms and descriptions used herein are set forth by way of illustration only and are not meant as limitations. In particular, although the present invention has been described by way of examples, a variety of compositions and methods would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

The foregoing descriptions of specific embodiments of the present invention are presented for purposes of illustration and description. They are not intended to be exhaustive or to limit the invention to the precise forms disclosed. Obviously, many modifications and variations are possible in view of the above teachings. While the embodiments were chosen and described in order to best explain the principles of the invention and its practical applications, thereby enabling others skilled in the art to best utilize the invention, various embodiments with various modifications as are suited to the particular use are also possible. The scope of the invention is to be defined only by the claims appended hereto, and by their equivalents.

What is claimed is:

1. A method of detecting the presence of a disease in a subject, the method comprising the steps of:
generating mass spectra data from a biological sample taken from the subject; and
comparing the mass spectra data to a prediction model, the prediction model being based on mass spectra data of biological samples taken from a population known to have the disease;
wherein the presence or non-presence of at least one marker identified in the prediction model in the mass spectra data from the biological sample indicates that the subject has the disease.

2. The method of claim 1, wherein the disease is cancer.

3. The method of claim 2, wherein the disease is cancer of the lung, head, neck, oral cavity, esophagus, pharynx, kidney, bladder or pancreas.

4. The method of claim 1, wherein the biological sample taken from the subject is a biological fluid.

5. The method of claim 4, wherein the biological fluid is serum.

6. The method of claim 4, wherein the biological fluid is plasma.

7. The method of claim 4, wherein the biological fluid is blood.

8. The method of claim 4, wherein the biological fluid is urine.

9. The method of claim 1, wherein the mass spectra data are generated by Matrix Assisted Laser Desorption/Ionization (MALDI) spectrometry.

10. A method of identifying a marker for a disease for use in detecting the disease in a subject, the method comprising the steps of:
generating a first set of mass spectra data, the first set of mass spectra data being generated from biological samples taken from a population known to have the disease;
generating a second set of mass spectra data, the second set of mass spectra data being generated from biological samples taken from a population known not to have the disease; and
comparing the first set of mass spectra data and the second set of mass spectra data to identify at least one peak indicating at least one marker for the disease.

11. The method of claim 10, wherein the disease is cancer.

12. The method of claim 11, wherein the at least one marker identifies the presence of tumors.

13. The method of claim 1 1, wherein the disease is cancer of the lung, head and neck, oral cavity, esophagus, pharynx, kidney, bladder or pancreas.

14. The method of claim 10, wherein a peak is identified as a marker for the disease if it appears in one of the sets of mass spectra data and does not appear in the other of the sets of mass spectra data.

15. The method of claim 10, further comprising the step of using the markers to create a prediction model for use in detecting the presence of the disease in a subject.

16. The method of claim 10, wherein the mass spectra data are generated by Matrix Assisted Laser Desorption/Ionization (MALDI) spectrometry.

17. The method of claim 10, wherein each population includes a plurality of subjects and a sample is taken from each of the plurality of subjects.
